(19) United States
(12) Patent Application Publication
(10) Pub. No.: US 2003/0052559 A1
(43) Pub. Date: Mar. 20, 2003

(54) Electric motor

(75) Inventor: Niels Christian Weihrauch, Nordhackstedt (DE)

Correspondence Address: ALTERA LAW GROUP, LLC, 6500 CITY WEST PARKWAY, SUITE 100, MINNEAPOLIS, MN, 55344-7704, US

(73) Assignee: Danfoss Compressors GmbH, Flensburg (DE)

(21) Appl. No.: 10/213,465

(22) Filed: Aug. 6, 2002

(30) Foreign Application Priority Data
Sep. 15, 2001 (DE) 101 45 615.8

(51) Int. Cl. H02K 16/00; H02K 16/02

(52) U.S. Cl. 310/114

(57) ABSTRACT

Specified is an electric motor with a stator (1) that displays a rotating-field-generating rotating-field winding arrangement and a bore (3) in which is arranged a rotor.

The object is to increase the efficiency of the motor.

To this end, provision is made in the stator (1) for an auxiliary rotor arrangement that displays at least one auxiliary rotor (4, 5) with a magnetic-field generation device, which is arranged in an auxiliary rotor bore (12, 13).

The invention relates to an electric motor with a stator, which stator displays a rotating-field winding arrangement that generates a rotating field and a bore in which a rotor is arranged.

When the rotating-field winding arrangement is supplied with a multiphasic alternating current, the phases of which are appropriately shifted with respect to one another, there arises a rotating magnetic field, which acts upon the rotor and pulls the latter along with it. For the purpose of explaining the present invention, for the present it matters not whether the motor operates as an asynchronous or a synchronous motor.

If necessary, the rotating-field winding arrangement can also be supplied with only a single-phase current, when provision is made for means by which an auxiliary phase can be generated.

The current conducted by the rotating-field winding arrangement is used in a known manner to generate a rotational moment and, in part, to magnetize the stator or yoke. This magnetization current does not contribute to the axial output, thus does not lead to an increasing of the rotational moment.

The invention is based on the task of enhancing the efficiency of the motor.

This task is accomplished, in an electric motor of the type specified above, in that provision is made in the stator for an auxiliary rotor arrangement, which displays at a minimum an auxiliary rotor with a magnetic-field generating apparatus, which auxiliary rotor is arranged in an auxiliary rotor bore.

With the auxiliary rotor arrangement, it is possible to reduce the portion of the current in the rotating-field winding arrangement used for the magnetization. Thus, a larger portion of this current is available for the generation of the rotational moment. The magnetic field in the stator is now at least partially generated by the auxiliary rotor arrangement. Since the auxiliary rotor(s) of the auxiliary rotor arrangement rotate(s) synchronously with the stator main field, it is possible to generate a resulting, correspondingly-rotating magnetic field. Magnetization losses of the current are, in the process, accordingly reduced, and, in the final analysis, there results an electric motor with approximately 5% fewer losses in comparison to a motor without an auxiliary rotor arrangement.

The use of additional magnets in the stator is known in itself. U.S. Pat. No. 5,455,473 A shows a reluctance motor that displays magnets that are embedded in the yoke. Here, it is a matter of two bar magnets that extend in the axial direction and are inserted into opposite sides of the yoke. The bar magnets are connected to an adjustment device, so that their position in the yoke can be changed. Depending on whether a large or a small rotational moment is to be produced, the magnets are pushed completely into the yoke or are withdrawn completely from the latter. Of course, a reluctance motor requires no rotating field in order to cause the rotor to rotate. It suffices that one magnetic pole travels from one stator pole cog to another stator pole cog, and shortly thereafter springs back again to the first pole cog.

U.S. Pat. No. 4,563,604 A describes a stepper motor in which two rotors are arranged in the stator yoke, which rotors are designed in each case as permanent magnets. These rotors drive, in common, a wheel, and half of the magnetic flux in the common stator flows through each rotor.

Preferably, the stator displays an air gap that passes through the auxiliary rotor bore and divides the stator. By this means, a magnetic short-circuiting of the auxiliary rotor is prevented. Appropriately, at least one end of the air gap terminates in a stator groove.

Preferably, the magnetic-field generation apparatus displays a permanent magnet, the two poles of which are aligned with the rotational axis of the auxiliary rotor. This results in the most effective generation of the magnetic field in the stator. Moreover, the structure of such an auxiliary rotor is relatively simple. Such auxiliary rotors can therefore be manufactured relatively inexpensively.

Preferably, the auxiliary rotor arrangement displays several auxiliary rotors. Of course, in principle it is sufficient for the auxiliary rotor arrangement to display one auxiliary rotor. However, with several auxiliary rotors, the magnetic field can be distributed more evenly around the periphery of the stator bore in which the rotor is arranged.

Preferably, the auxiliary rotors are arranged symmetrically to a first plane and asymmetrically to a second plane, which is perpendicular to the first plane. Avoided thereby is a positioning of the pole pair, generated by the rotating-field winding arrangement, of the magnetic field such that the pole pair nearly fails to pass through the auxiliary rotor or rotors. Through the asymmetrical arrangement, it is ensured that the auxiliary rotor arrangement in every case provides a contribution to the generation of the magnetic field in the stator that is no longer negligible.

Preferably, in the case of two auxiliary rotors the second plane runs parallel to a plane that connects the rotational axes of the two auxiliary rotors. This is a relatively simple positioning rule. If the two auxiliary rotors are arranged at opposite sides of the rotor, then the orientation of the corresponding magnets is the same for the auxiliary rotors.

In a preferred configuration, provision is made for the auxiliary rotor arrangement to display two auxiliary rotors that are arranged so as to be 90° displaced from each other. This design has the advantage that a rotating magnetic field can be generated, the indicator of which, in the ideal case, describes a circle. If one visually describes the magnetic field as a vector, then, in the ideal case, this vector changes its length virtually not at all during a revolution. On the other hand, in the case of auxiliary rotors situated opposite to each other, the magnetic field, during a revolution, changes its strength and thus the vector changes its length, so that a rather elliptical shape is formed.

Preferably, the stator displays grooves for the rotating-field winding, of which grooves, those that are adjacent to the auxiliary-rotor bores are inclined with respect to the radial direction, towards the respective auxiliary rotor bores. It is thereby possible, in a simple manner, to arrange the air gap such that the magnetic field of the auxiliary rotor does not become short-circuited. Rather, the magnetic field of the auxiliary rotor has the possibility of becoming pointed towards the rotor, by means of the stator cog between the corresponding grooves.

In the following, the invention is described in detail with the aid of preferred embodiment examples, in conjunction with the drawings. These show:

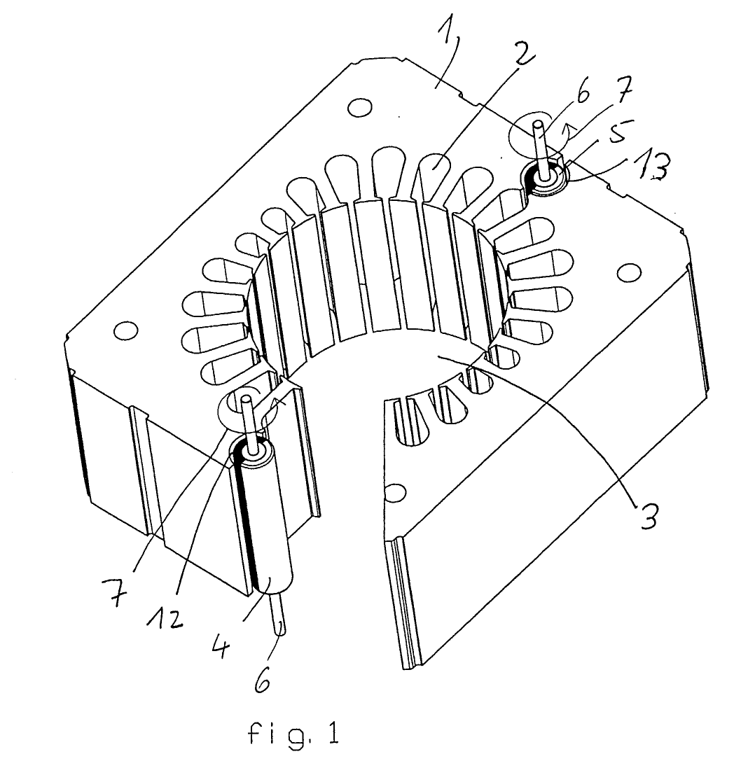

FIG. 1: a schematic, three-dimensional view of a stator of a first embodiment example with two auxiliary rotors

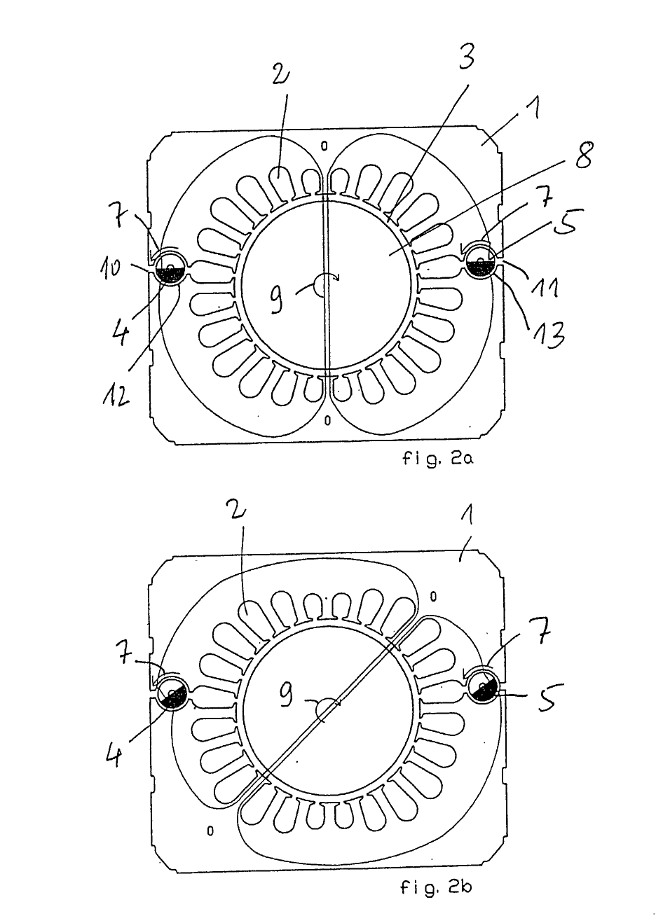

FIG. 2: the stator yoke in plan view with the auxiliary rotors in two different positions

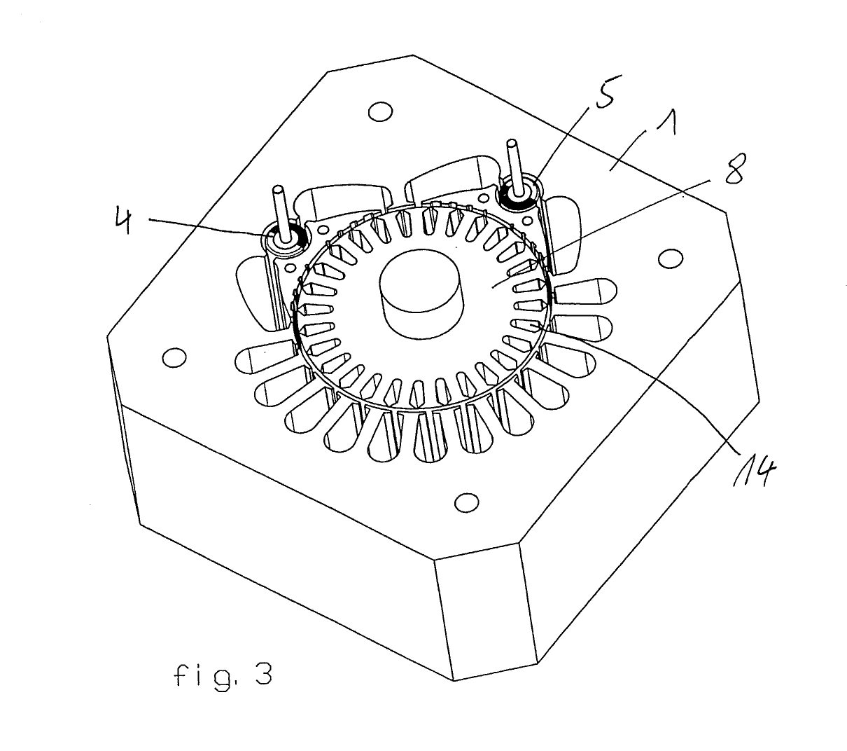

FIG. 3: in schematic, three dimensional view, a second embodiment example with two auxiliary rotors

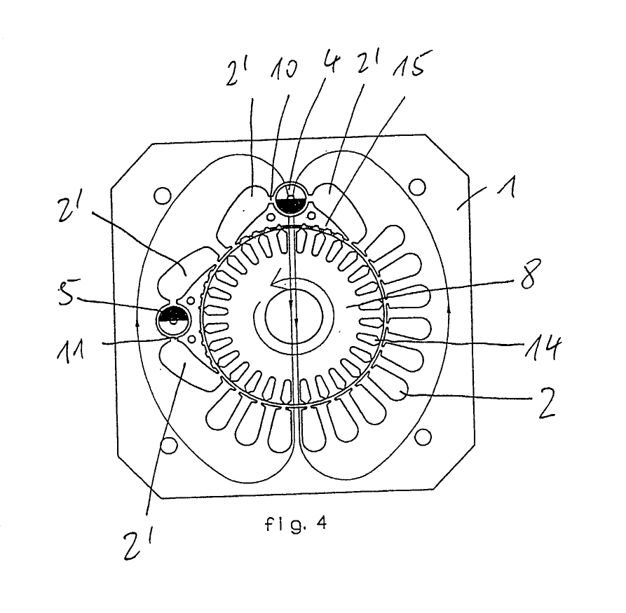

FIG. 4: the stator yoke according to FIG. 3 in plan view

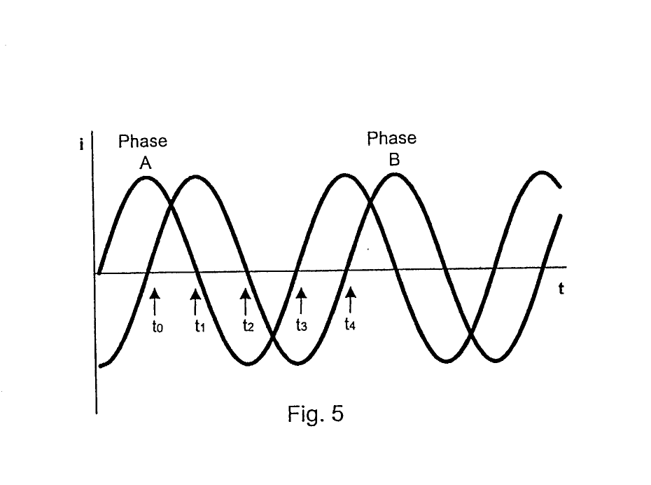

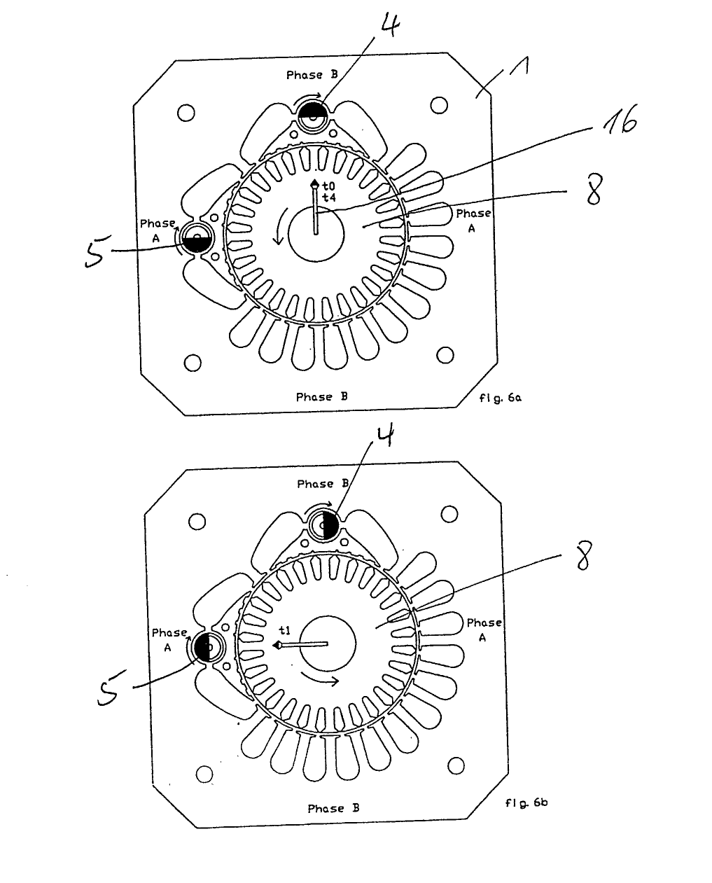

FIG. 5: the temporal course of the current in two stator windings

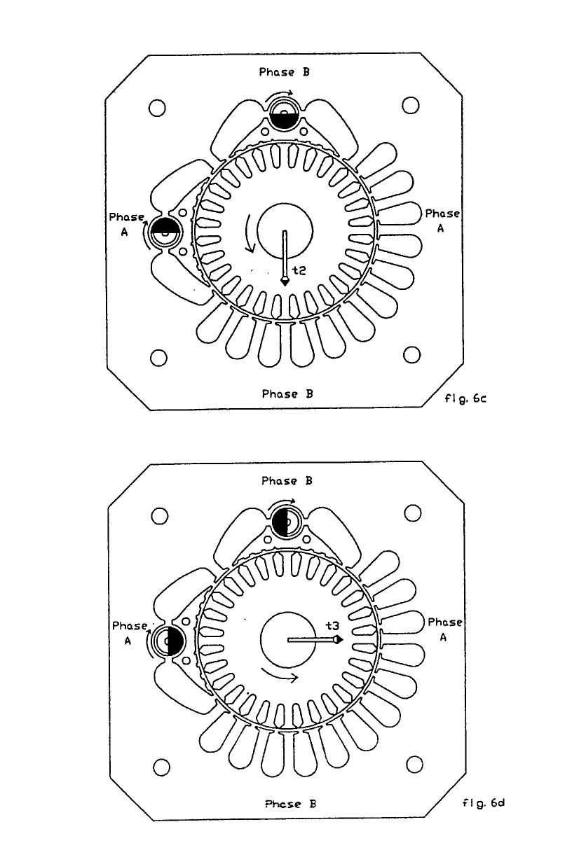

FIG. 6: the movements of the rotor and the auxiliary rotor during one electrical cycle

FIG. 1 shows, in a perspective representation, a stator 1 of an electric motor, with stator grooves 2 and a bore 3, in which a rotor can be accommodated. The stator 1 is usually formed conventionally as a sheet-metal bundle, i.e. it consists of a number of metal sheets electrically insulated with respect to each other, which are stacked along the axis of the bore 3 such that the represented block results. The grooves 2 are punched out of the metal sheets.

In a manner not shown in detail, but known in itself, several stator windings are accommodated in the grooves 2, which windings form a rotating-field winding arrangement. Basically, it suffices for this if provision is made for two phases, which are arranged spatially displaced 90° with respect to each other and are charged with currents that are electrically shifted 90° with respect to each other. Alternatively, one can also employ a single main winding, when provision is made for an auxiliary winding or a rotating field can be generated in some other manner. In the following exposition, the two windings are designated “winding A” or “phase A” and “winding B” or “phase B”.

When the windings are connected to appropriate voltages, there results a revolving magnetic field.

Additionally arranged in the stator 1 are two auxiliary rotors 4, 5, of which auxiliary rotor 4 is visible in its entire length, since the stator 1 is cut away in this vicinity. The auxiliary rotors 4, 5 are supported by shafts 6 (not illustrated in detail), which run parallel to the axis of the bore 3.

The auxiliary rotors 4, 5 are in each case designed as permanent magnets, the poles of which are orientated radially with respect to the shaft 6. In order to simplify the representation, the north pole is shown in black and the south pole in white.

Now, when the auxiliary rotors 4, 5 are turned in the direction of the arrow 7, preferably through the rotating main magnetic field, then they produce a premagnetization of the stator 1. In other words, the auxiliary rotors 4, 5 generate an auxiliary magnetic field. This auxiliary field overlaps the magnetic field that is produced by the current flowing in the rotating-field winding arrangement. Normally, the share of magnetization current in the total current of the motor is up to 20%. Now, through the auxiliary magnetic field produced by the auxiliary rotors 4, 5 the share of the magnetization current in the total current of the motor can be reduced and, with power output remaining constant, the total current can be reduced. Since the copper losses are proportionate to the square of the current, the copper losses are also reduced and the efficiency of the motor increases.

As can be seen in particular in FIG. 2, provision is made near each auxiliary rotor 4, 5 for an air gap 10, 11 in the stator 1, which air gap passes through the auxiliary rotor bore 12, 13 and divides the stator 1. The air gap 10, 11 therefore continues into a corresponding groove 2 in the stator . By means of the air gap 10, 11, a short-circuiting of the auxiliary rotor 4, 5 by the magnetic field is prevented.

One can further see from FIG. 2 that the two auxiliary rotors 4, 5 are arranged symmetrically with respect to a plane 0-0. This is a plane that, in the representation in FIG. 2a, runs from top to bottom.

The two auxiliary rotors 4, 5 are, however, arranged asymmetrically with respect to another symmetry plane of the stator 1, which plane stands perpendicularly to the plane 0-0. In other words, the two auxiliary rotors 4, 5 are arranged above this symmetry plane of the stator. The connection line between the shafts 6 of the two auxiliary rotors 4, 5 runs parallel to this symmetry plane. Accordingly, the portion of the stator 1 above the auxiliary rotors 4, 5 (with reference to the representation of FIG. 2) is smaller than the portion underneath. By this means is to be avoided an inactive positioning of the pole pair produced by the windings in the grooves 2, i.e. it should not happen that the magnetic field lines nearly fail to pass through the auxiliary rotors. This could be the case if the auxiliary rotors 4, 5 were arranged 180° apart.

In principle, the premagnetization could be produced using only one auxiliary rotor, which, however, reduces the benefit of premagnetizing the stator 1.

FIG. 2 shows, in two rotational positions of the rotating field, the positions of the auxiliary rotors 4, 5. The field lines sketched in are to be understood in a qualitative manner, i.e. they graphically reproduce the course of the magnetic field. The resulting magnetic field is represented here, i.e. the magnetic field that results from the overlapping of the auxiliary magnetic field of the auxiliary rotors 4, 5 and the main magnetic field of the rotating-field winding arrangement in the grooves 2. It is evident from FIG. 2a that the resulting magnetic field does not differ from a magnetic field that would be generated exclusively by the rotating-field winding arrangement in the grooves 2.

The auxiliary rotors 4, 5 rotate synchronously with the rotating field, but in a direction opposite to the rotating direction of the rotor 8, which can be seen from a comparison of FIGS. 2a and 2b. The auxiliary rotors 4, 5, in contrast to the rotor 8, yield no axial power. Consequently, they also cause no polar shift in the resulting magnetic field, i.e. there is no angle between the magnetic field of the auxiliary rotors 4, 5 and the magnetic field that would exist if only the stator windings were active.

For the following exposition, an ideal state of the motor is assumed. When the motor is yielding no mechanical power, i.e. when the rotor 8 is moving synchronously with the rotating field of the stator 1, the magnetic flux lines run as shown in FIG. 2a for a time point tₐ. At this time point tₐ, the above-mentioned axis 0-0 can be sketched in, which axis at the same time describes the geometrical vertical center line. The resulting magnetic field has, at time point tₐ, the same direction as the axis 0-0 and the shape of the field is the same as that generated by the windings in the stator 1 alone. One can conclude from this that if the resulting rotating field would be stationary, the magnetization current in the windings is zero.

Of course, the magnetic field rotates, and the energy necessary for this rotation is supplied by the stator windings. FIG. 2b shows the field course after the auxiliary rotors 4, 5 have rotated 45° in a counterclockwise direction. The resulting rotating-field pointer on the axis 0-0 has also rotated 45°, but in a clockwise direction. This rotation has been effected by the current in the rotating-field winding arrangement, which fact is recognizable in the field lines that enclose the individual stator grooves 2. The auxiliary rotors 4, 5 thus supply the magnetic field, but do not produce the change in the direction of the field. Accordingly, the motor output delivered to the shaft of the rotor 8 is supplied exclusively by the stator windings.

The magnetic induction in the stator 1 can amount to approximately 1 tesla and derives predominantly from the auxiliary rotors 4, 5. If one imagines that the resulting magnetic field rotates in the clockwise direction, then both auxiliary rotors 4, 5 move in the counterclockwise direction, as is indicated by the arrows 7 in FIGS. 2a and 2b. The rotor 8 and the auxiliary rotors 4, 5 therefore move, as already mentioned, in opposite directions.

The stator is magnetically pre-magnetized. If one imagines the magnetic field visually as a vector, the direction of which corresponds to the direction of the magnetic field and the length of which corresponds to the strength of the magnetic field, then the length of the vector changes during a revolution. There results, so to speak, an elliptical rotating field. In the configuration according to FIG. 2, the shape of this rotating field is not supported by the auxiliary rotors.

If one would like to have the shape of the resulting magnetic field be supported by the auxiliary rotors 4, 5, in other words, the shape is to be held essentially constant during a revolution, a solution such as that represented in FIG. 3 is to be used. There, parts that are similar to and correspond to those of FIGS. 1 and 2 are provided with the same reference numerals.

FIG. 3 shows, in perspective representation, a second embodiment form of a motor with a stator 1 and two auxiliary rotors 4, 5. FIG. 4 shows a corresponding plan view with a schematic representation of the field lines of the magnetic field. A conventional rotor 8 with grooves 14 to accommodate aluminum rods or another type of ladder is also shown.

On the assumption that the rotor 8 yields no mechanical power, i.e. that the rotor 8 moves synchronously with the rotating field, FIG. 4 shows the distribution of the field lines of the resulting magnetic field, which arises from the auxiliary magnetic field of the auxiliary rotors 4, 5 and from the rotating-field winding arrangement of the stator grooves 2. It is evident that the auxiliary rotor 4 is active while the auxiliary rotor 5 is positioned so as to be magnetically inactive. This configuration, with two auxiliary rotors 4, 5 arranged with a 90° angle between them, generates, in conjunction with the field of the rotating-field winding arrangement, a resulting magnetic field that during a revolution describes, in the ideal case, a circle, i.e. the vector of the magnetic field does not change its length. The auxiliary rotors 4, 5 here support the formation of this circular shape.

This is made clear by a comparison of FIGS. 2 and 4. In FIG. 2a, the vector of the magnetic field has its greatest length, because here the two auxiliary rotors 4, 5, which are designed as permanent magnets, are both magnetically active. If, in contrast, the magnetic field of the rotating-field winding arrangement were rotated 90°, then both auxiliary rotors 4, 5 would become virtually inactive from a magnetic standpoint, and the action of their magnetic field would approach zero. In this situation, the vector is shortest.

This problem disappears in the configuration according to FIG. 3. In order to generate the ideal circular, magnetic field, it is of a certain significance that the pole pieces in which the auxiliary rotors 4, 5 are embedded be well designed.

As can be seen in FIG. 4, the auxiliary rotors 4, 5 can be supported by the fact that the grooves 2′ adjacent to the auxiliary rotors 4, 5 are inclined with respect to the radial direction of the rotor 8, this inclination being towards the auxiliary rotors 4, 5. These adjacent grooves are then connected to each other by the air gap 10, 11. Resulting from this are pole pieces 15 that serve to guide the auxiliary field of the auxiliary rotors 4, 5. Each of the grooves 2′ has a surface or volume that amounts to three times the surface or volume of an “ordinary” groove 2.

With the aid of FIGS. 5 and 6, a complete revolution of the rotor 8 in the stator 1 will now be described.

FIG. 5 shows the course of two currents iA and iB in stator windings A and B, which are designated “Phase A” and “Phase B” in FIG. 6. The stator windings are spatially displaced 90° from each other. The two currents iA and iB are electrically shifted 90° with respect to each other.

At time point t₀, the current in winding A is at a maximum, so that a magnetic field standing perpendicular to the winding axis results. This magnetic field is represented by a pointer 16, and in the representation of FIG. 6a the magnetic north pole is indicated by the tip of the pointer. The auxiliary rotor 4 positions itself so that its south pole (white) faces away from the north pole of the magnetic field and thus supports the magnetic field, since the magnetic directions of the magnetic field and the auxiliary field of the auxiliary rotor 4 coincide.

At time point t₁, the auxiliary rotors 4, 5 and the rotor 8 have rotated, the latter in the counterclockwise direction, because winding B has formed a pole pair perpendicular to the axis of the rotor 8. In contrast, the auxiliary rotors 4, 5 have rotated in the clockwise direction. It can be seen that the pole direction the auxiliary rotors 4, 5 are, in both cases, opposite to each other. In this case, auxiliary rotor 5 is active with respect to Phase A and supports the magnetic field of the rotating-field winding arrangement.

At time points t₂ and t₃, which correspond to FIGS. 6c and 6d, respectively, the field is turned again 90° in the clockwise direction. Since the auxiliary rotors 4, 5 are rotated correspondingly, the latter support the formation of the main magnetic field. Thus, at no point does there arise a situation in which the rotating field is nearly zero. The variation of the length of the rotating-field vector 16 is, during a revolution, smaller than in the case of the embodiment example of FIG. 2. This signifies a more uniform motor operation.

Shown here is an embodiment example with a short-circuit rotor as the rotor 8. However, it is also possible to use a permanently excited rotor.

1. Electric motor with a stator that displays a rotating-field-generating rotating-field winding arrangement and a bore, in which a rotor is arranged, characterized in that provision is made in the stator for an auxiliary rotor arrangement that displays at least one auxiliary rotor (4, 5) comprising a magnetic-field generation device, which auxiliary rotor is arranged in an auxiliary-rotor bore (12, 13).

2. Motor according to claim 1, characterized in that the stator (1) displays an air gap (10, 11) that passes through the auxiliary rotor bore (12, 13) and divides the stator (1).

3. Motor according to claim 1 or 2, characterized in that the magnetic-field generation device displays a permanent magnet, the two poles of which are orientated radially with respect to the rotation shaft (6) of the auxiliary rotor (4, 5).

4. Motor according to one of the claims 1 through 3, characterized in that the auxiliary rotor arrangement displays several auxiliary rotors (4, 5).

5. Motor according to claim 4, characterized in that the auxiliary rotors (4, 5) are arranged symmetrically with respect to a first plane (O-0) and asymmetrically with respect to a second plane that stands perpendicularly on the first plane.

6. Motor according to claim 5, characterized in that, in the case of application of two auxiliary rotors (4, 5), the second plane runs parallel to a plane that connects the rotation shafts (6) of the two auxiliary rotors (4, 5).

7. Motor according to one of the claims 4 through 6, characterized in that the auxiliary rotor arrangement displays two auxiliary rotors (4, 5) that are spatially separated 90° from each other.

8. Motor according to claim 7, characterized in that the stator (1) displays grooves (2) for the rotating-field winding arrangement, of which grooves, those (2′) that that are adjacent to the auxiliary rotor bores (12, 13) are inclined with respect to the radial direction, this inclination being towards the respective auxiliary rotor bores (12, 13).
